(19) United States
(12) Patent Application Publication
(10) Pub. No.: US 2015/0180248 A1
(43) Pub. Date: Jun. 25, 2015

(54) APPARATUS AND METHOD FOR PROTECTING BATTERY FROM OVERVOLTAGE

(71) Applicant: Samsung SDI Co., Ltd., Yongin-si (KR)

(72) Inventor: Sung-Woo Yang, Yongin-si (KR)

(21) Appl. No.: 14/539,836

(22) Filed: Nov. 12, 2014

(30) Foreign Application Priority Data
Dec. 20, 2013 (KR) 10-2013-0160553

(51) Int. Cl. H02J 7/00

(52) U.S. Cl. CPC H02J 7/0029; H02J 7/007

(57) ABSTRACT

An apparatus and method for protecting a battery from overvoltage are disclosed. In one aspect, a battery management system (BMS) includes a first battery protection circuit configured to receive a battery charging voltage and generate a first control signal when the battery charging voltage is outside a first reference voltage range. The BMS also includes a second battery protection circuit configured to receive the battery charging voltage and generate a second control signal when the battery charging voltage is outside a second reference voltage range. The BMS further includes a controller configured to control a main relay, electrically connected to the BMS, based at least on the first control signal.

### CROSS-REFERENCE TO RELATED APPLICATIONS

This application claims priority to and the benefit of Korean Patent Application No. 10-2013-0160553 filed in the Korean Intellectual Property Office on Dec. 20, 2013, the entire contents of which are incorporated herein by reference.

### BACKGROUND

1. Field

The described technology generally relates to an apparatus and a method for protecting a battery from overvoltage.

2. Description of the Related Technology

A battery management system (BMS) is a real-time management system for monitoring the performance of a battery. The BMS is used to manage rechargeable batteries that can be repeatedly charged and discharged so as to prevent a malfunction thereof.

Environmental changes occurring around the battery charging device can be detected and collected by the device. The collected data can be managed by a controller and a central processing unit (CPU) of the BMS.

Typically, a battery charging module of the BMS is managed by a microcontroller unit (MCU) in the BMS.

When the MCU detects a charging voltage that is outside the voltage range of the battery charging module, it electrically disconnects a main relay to protect the battery.

### SUMMARY OF CERTAIN INVENTIVE ASPECTS

One inventive aspect is an operation method of a battery management system (BMS) for operating a main relay by comparing a reference voltage range with a battery charging voltage.

The operation method of the BMS includes: receiving control signals respectively transmitted from a battery protection circuit and a microcontrol unit (MCU) by comparing the reference voltage range with the charging voltage; and opening the main relay if a relay open signal among the control signals is received from at least one of the battery protection circuit and the MCU.

In the operation method of the BMS described above, receiving the control signals can include receiving the relay open signal generated from the battery protection circuit or the MCU if the charging voltage is out of the reference voltage range.

Another aspect is a BMS for operating a main relay by comparing a reference voltage range with a battery charging voltage.

The BMS includes: a battery protection unit which compares the reference voltage range with the charging voltage by using a protection circuit and transmits a control signal for the main relay according to a comparison result; a microcontrol unit which compares the reference voltage range with the charging voltage by using a microprocessor and transmits a control signal for the main relay according to a comparison result; and a control signal mixer which receives the control signals from the battery protection unit and the MCU so as to operate the main relay.

In the BMS, the battery protection unit and the MCU can respectively transmit the control signal for opening the main relay if the charging voltage is out of the reference voltage range.

In the BMS, the reference voltage range of the battery protection unit can be larger than that of the MCU.

In the BMS, the battery protection unit can include a high-voltage comparison unit which generates a control signal for opening the main relay if the charging voltage exceeds the reference high-voltage by comparing the reference high-voltage with the charging voltage, and a noise reduction unit eliminating noise included in the first control signal.

In the BMS, the battery protection unit can include a low-voltage comparison unit which generates the control signal for opening the main relay if the charging voltage falls below the reference low-voltage by comparing the reference low-voltage with the charging voltage, and a noise reduction unit eliminating noise included in the second control signal.

Another aspect is a method of operating a battery management system (BMS), the method comprising receiving a battery charging voltage outputting a first control signal when the battery charging voltage is outside a first reference voltage range, and opening a main relay, electrically connected to the BMS, based at least on the first control signal.

The above method further comprises outputting a second control signal when the battery charging voltage is outside a second reference voltage range. The above method further comprises combining the first and second control signals into an open relay signal. In the above method the opening is performed based on the open relay signal. In the above method, the first and second reference voltage ranges are different from each other.

In the above method, the first control signal is generated by an analog-based component. In the above method, the first control signal is output regardless of the status of the second control signal.

Another aspect is a battery management system (BMS), comprising a battery protection circuit and a control signal mixer. The battery protection circuit is configured to receive a battery charging voltage and output a first control signal when the battery charging voltage is outside a first reference voltage range. The control signal mixer is configured to output an open relay signal to a main relay based at least on the first control signal.

The above BMS further comprises a microcontroller unit (MCU) configured to receive the battery charging voltage and output a second control signal when the battery charging voltage is outside a second reference voltage range, wherein the control signal mixer is further configured to combine the first and second control signals into the open relay signal. In the above BMS the first and second reference voltage ranges are different from each other. In the above BMS, the first reference voltage range is greater than the second reference voltage range.

In the above BMS, the first voltage range includes and is between first and second reference voltages. In the above BMS, the battery protection unit includes a first comparator, a second comparator, and a noise reducer. In the above BMS, the first comparator is configured to generate a first output signal for opening the main relay when the battery charging voltage is less than the first reference voltage. In the above BMS, the second comparator is configured to generate a second output signal for opening the main relay when the battery charging voltage is greater than the second reference voltage. In the above BMS, the noise reducer is configured to combine the first and second output signals and reduce noise included in the combined signal so as to output the first control signal.

Another aspect is a battery management system (BMS), comprising a first battery protection circuit, a second battery protection circuit and a controller. The first battery protection circuit is configured to receive a battery charging voltage and generate a first control signal when the battery charging voltage is outside a first reference voltage range. The second battery protection circuit is configured to receive the battery charging voltage and generate a second control signal when the battery charging voltage is outside a second reference voltage range. The controller is configured to control a main relay, electrically connected to the BMS, based at least on the first control signal.

In the above BMS, the first battery protection circuit is configured to analogally generate the first control signal, and the second battery protection circuit is configured to digitally generate the second control signal. In the above BMS, the first reference voltage range includes and is between first and second reference voltages. In the above BMS, the first battery protection circuit includes a first comparator, a second comparator and a noise reducer. In the above BMS, the first comparator is configured to generate a first output signal for opening the main relay when the battery charging voltage is less than the first reference voltage. In the above BMS, the second comparator is configured to generate a second output signal for opening the main relay when the battery charging voltage is greater than the second reference voltage. In the above BMS, the noise reducer is configured to combine the first and second output signals and reduce noise included in the combined signal so as to output the first control signal.

In the above BMS, the second reference voltage range includes and is between third and fourth reference voltages. In the above BMS, the second battery protection circuit includes a microprocessor configured to output the second control signal when the battery charging voltage is less than the third reference voltage or greater than the fourth reference voltage. In the above BMS, the controller is further configured to open the main relay only based on the first control signal when the second battery protection circuit malfunctions.

In the above BMS, the controller is further configured to open the main relay based on the first and second control signals. In the above BMS, the first and second reference voltage ranges are different from each other. In the above BMS, the first reference voltage range is greater than the second reference voltage range.

According to at least one embodiment, even though the battery charging voltage is in an overvoltage state to cause an MCU malfunction, the battery protection unit consisting of hardware detects the overvoltage state of the battery charging voltage so as to open a main relay, thereby guaranteeing reliability of the battery management system (BMS).

### BRIEF DESCRIPTION OF THE DRAWINGS

FIG. 1 illustrates a battery management system (BMS) according to an exemplary embodiment.

FIG. 2 illustrates a battery protection unit according to an exemplary embodiment.

FIG. 3 is a flowchart of a circuit protection process of the battery management system (BMS) according to an exemplary embodiment.

### DETAILED DESCRIPTION OF CERTAIN INVENTIVE EMBODIMENTS

In the following detailed description, only certain exemplary embodiments of the described technology have been shown and described, simply by way of illustration.

As those skilled in the art would realize, the described embodiments can be modified in various different ways, all without departing from the spirit or scope of the described technology.

Accordingly, the drawings and description are to be regarded as illustrative in nature and not restrictive. Like reference numerals designate like elements throughout the specification.

Throughout this specification, unless explicitly described to the contrary, the word “comprise” and variations such as “comprises” or “comprising” will be understood to imply the inclusion of stated elements but not the exclusion of any other elements.

In addition, the terms “-er”, “-or”, “module”, and “block” described in the specification mean units for processing at least one function and operation, and can be implemented by hardware components or software components, and combinations thereof. In this disclosure, the term “substantially” means completely, almost completely or to any significant degree.

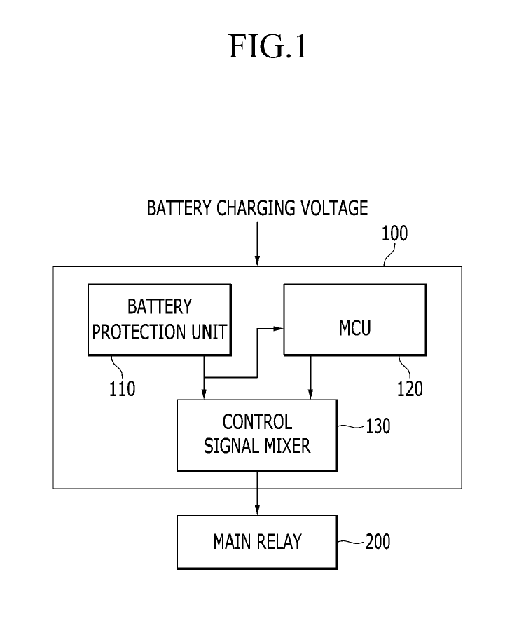

FIG. 1 illustrates a battery management system (BMS) 100 according to an exemplary embodiment.

Referring to FIG. 1, the BMS 100 includes a battery protection unit or a battery protection circuit or a first battery protection circuit 110, a microcontroller unit (MCU) or a second battery protection circuit 120, and a control signal mixer or main relay controller 130.

When a charging voltage of at least one battery (not shown) is input (e.g., from a power source), the battery protection unit 110 can compare the charging voltage to first and second reference voltages by using a protection circuit. The battery is a secondary or rechargeable battery which is often a battery pack made up of multiple battery cells.

The battery protection unit 110 can output a first control signal according to the charging voltage. The first control signal can open or electrically disconnect a main relay so as to protect the battery.

The battery protection unit 110 can transmit the control signal when the charging voltage is less than the first reference voltage or greater than the second reference voltage. A first reference voltage range can be voltages between and including the first and second reference voltages.

In some embodiments, the first reference voltage range is different from a second reference voltage range of the MCU 120. The second reference voltage range can be voltages between and including third and fourth reference voltages of the MCU 120.

When the battery protection unit 110 operates as a secondary battery protection unit, the first reference voltage range can be set greater than the second reference voltage range.

For example, when the second reference voltage range is about 3 V to about 4 V, the first reference voltage range can be about 2.5 V to about 4.5 V, but the reference voltage ranges are not limited thereto.

The MCU 120 can measure the charging voltage. After measuring the charging voltage, the MCU 120 can compare the measured charging voltage to the third and fourth reference voltages by using software, such as an internal program executed by a microprocessor.

For example, when the charging voltage is greater than the fourth reference voltage or less than the third reference voltage, the MCU 120 can output a second control signal to open the main relay 200 so as to protect the battery.

In addition, the MCU 120 can receive the first control signal from the battery protection unit 110 such that the MCU 120 compares the first control signal to the second control signal so as to store a comparison result as a log.

The control signal mixer 130 can output an open relay signal so as to operate the main relay 200. The open relay signal can be based on at least one of the first and second control signals.

When at least one of the battery protection unit 110 and the MCU 120 transmits the first and/or second control signal, the control signal mixer 130 can send the open relay signal so as to open the main relay 200 to protect the battery. When the control signal mixer 130 does not receive a first or second control signal, the main relay 200 will remain closed or electrically connected.

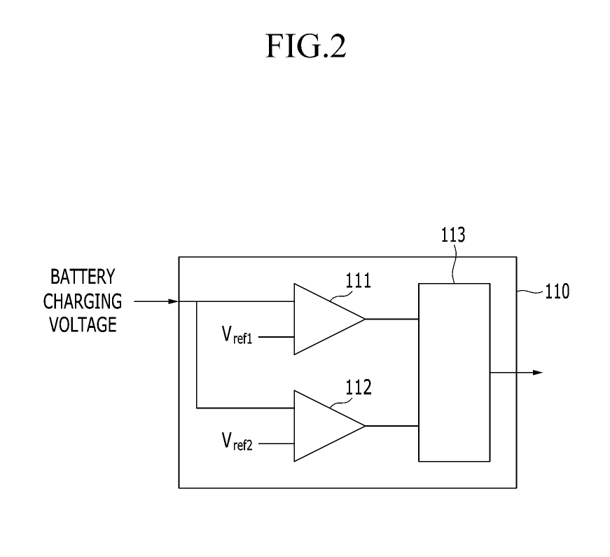

FIG. 2 illustrates the battery protection unit 110 according to an exemplary embodiment.

Referring to FIG. 2, the battery protection unit 110 includes a first voltage comparison unit or first comparator 111, a second voltage comparison unit or second comparator 112, and a noise reduction unit or a noise reducer 113.

In an exemplary embodiment, each of the first and second voltage comparison units 111 and 112 can be implemented with an operational amplifier (OP AMP).

In another exemplary embodiment, the first and second voltage comparison units 111 and 112 can be implemented with a single module.

The first voltage comparison unit 111 outputs a first output signal if the charging voltage is less than the first reference voltage (V_{ref1}).

The second voltage comparison unit 112 outputs a second output signal if the charging voltage is greater than the second reference voltage (V_{ref2}).

When at least one of the output signals is received, the noise reduction unit 113 transmits the first control signal. Thus, the first control signal can be stably transmitted to the control signal mixer 130 through the noise reduction unit 113.

That is, the noise reduction unit 113 can minimize or substantially eliminate noise added to the output signals. The control signal mixer 130 can substantially accurately recognize the first control signal, thereby reducing a risk of wrongly opening or closing the main relay 200.

The noise reduction unit 113 can be implemented with a low pass filter (LPF) including an OP AMP.

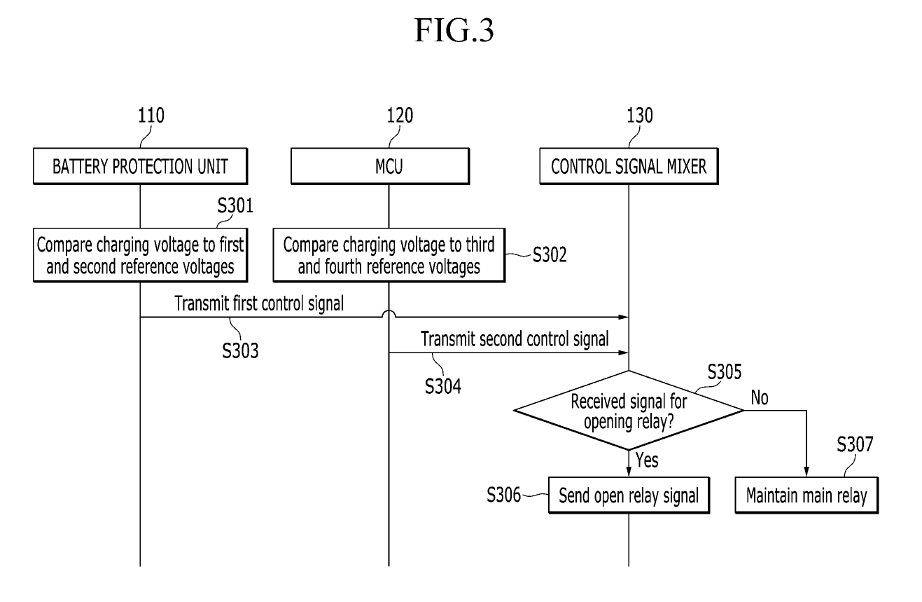

FIG. 3 is a flowchart of a circuit protection process of the BMS 10 according to an exemplary embodiment.

In some embodiments, the FIG. 3 procedure is implemented in a conventional programming language, such as C or C++ or another suitable programming language. The program can be stored on a computer accessible storage medium of the BMS 100, for example, a memory (not shown) of the BMS 100 or the MCU 120. In certain embodiments, the storage medium includes a random access memory (RAM), hard disks, floppy disks, digital video devices, compact discs, video discs, and/or other optical storage mediums, etc. The program can be stored in the processor. The processor can have a configuration based on, for example, i) an advanced RISC machine (ARM) microcontroller and ii) Intel Corporation's microprocessors (e.g., the Pentium family microprocessors). In certain embodiments, the processor is implemented with a variety of computer platforms using a single chip or multichip microprocessors, digital signal processors, embedded microprocessors, microcontrollers, etc. In another embodiment, the processor is implemented with a wide range of operating systems such as Unix, Linux, Microsoft DOS, Microsoft Windows 7/Vista/2000/9x/ME/XP, Macintosh OS, OS/2, Android, iOS and the like. In another embodiment, at least part of the procedure can be implemented with embedded software. Depending on the embodiment, additional states can be added, others removed, or the order of the states changed in FIG. 3.

Referring to FIG. 3, the battery protection unit 110 and the MCU 120 compare the charging voltage to the reference voltages (S301 and S302)

According to exemplary embodiments, the battery protection unit 110 determines whether the charging voltage is less than the first reference voltage (V_{ref1}) or greater than the second reference voltage (V_{ref2}).

In S302, the MCU 120 compares the charging voltage to the third and/or fourth reference voltages. The MCU 120 can include a microprocessor.

The battery protection unit 110 and the MCU 120 can respectively transmit the first and second control signals to the main relay 200 via the control signal mixer 130 based on the comparison results described above (S303 and S304).

For example, the battery protection unit 110 and the MCU 120 can transmit the control signals to the control signal mixer 130 when the charging voltage is less than at least one of the first and third reference voltages or is greater than at least one of the second and fourth reference voltages.

In some embodiments, when the charging voltage is about 3.5 V, the first voltage is about 3 V, the second voltage is about 4 V, the third voltage is about 2.5 V and the fourth voltage is about 4.5 V, the charging voltage falls within both the first and second reference voltage ranges. In these embodiments, both the battery protection unit 110 and the MCU 120 do not transmit the control signals.

In another embodiment, the main relay 200 maintains its operational state by not receiving the open relay signal from the control signal mixer 130.

In some embodiments, when the charging voltage is about 4.2 V, it does not fall within the first reference voltage range and the MCU 120 transmits the second control signal to the control signal mixer 130.

In this case, the battery protection unit 110 can play an auxiliary role in protecting the battery in addition to a battery protection operation of the MCU 120.

Next, the control signal mixer 130 monitors whether at least one of the control signals is received (S305).

When the control signal mixer 130 receives at least one of the control signals, the control signal mixer 130 outputs the open relay signal so as to open the main relay 200 and thus, protect the battery (S306). However, when at least one of the control signals is not received, the open relay signal is not output, and thus, the state of the main relay 200 is maintained (S307).

According to the exemplary embodiments, even though the charging voltage is in an overvoltage state and the MCU 120 does not transmit the second control signal, the battery protection unit 110 can detect the overvoltage state and open the main relay 200, thereby substantially guaranteeing reliability of the BMS 100.

While the inventive aspects have been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of operating a battery management system (BMS), the method comprising:
receiving a battery charging voltage; outputting a first control signal when the battery charging voltage is outside a first reference voltage range; and
opening a main relay, electrically connected to the BMS, based at least on the first control signal.

2. The method of claim 1, further comprising outputting a second control signal when the battery charging voltage is outside a second reference voltage range.

3. The method of claim 2, further comprising combining the first and second control signals into an open relay signal.

4. The method of claim 3, wherein the opening is performed based on the open relay signal.

5. The method of claim 2, wherein the first and second reference voltage ranges are different from each other.

6. The method of claim 1, wherein the first control signal is generated by an analog-based component.

7. The method of claim 1, wherein the first control signal is output regardless of the status of the second control signal.

8. A battery management system (BMS), comprising:
a battery protection circuit configured to i) receive a battery charging voltage and ii) output a first control signal when the battery charging voltage is outside a first reference voltage range; and
a control signal mixer configured to output an open relay signal to a main relay based at least on the first control signal.

9. The BMS of claim 8, further comprising a microcontroller unit (MCU) configured to i) receive the battery charging voltage and ii) output a second control signal when the battery charging voltage is outside a second reference voltage range, wherein the control signal mixer is further configured to combine the first and second control signals into the open relay signal.

10. The BMS of claim 9, wherein the first and second reference voltage ranges are different from each other.

11. The BMS of claim 10, wherein the first reference voltage range is greater than the second reference voltage range.

12. The BMS of claim 8, wherein the first voltage range includes and is between first and second reference voltages, and wherein the battery protection unit includes:
a first comparator configured to generate a first output signal for opening the main relay when the battery charging voltage is less than the first reference voltage;
a second comparator configured to generate a second output signal for opening the main relay when the battery charging voltage is greater than the second reference voltage; and
a noise reducer configured to combine the first and second output signals and reduce noise included in the combined signal so as to output the first control signal.

13. A battery management system (BMS), comprising:
a first battery protection circuit configured to receive a battery charging voltage and generate a first control signal when the battery charging voltage is outside a first reference voltage range;
a second battery protection circuit configured to receive the battery charging voltage and generate a second control signal when the battery charging voltage is outside a second reference voltage range; and
a controller configured to control a main relay, electrically connected to the BMS, based at least on the first control signal.

14. The BMS of claim 13, wherein the first battery protection circuit is configured to analogally generate the first control signal, and wherein the second battery protection circuit is configured to digitally generate the second control signal.

15. The BMS of claim 13, wherein the first reference voltage range includes and is between first and second reference voltages, and wherein the first battery protection circuit includes:
a first comparator configured to generate a first output signal for opening the main relay when the battery charging voltage is less than the first reference voltage;
a second comparator configured to generate a second output signal for opening the main relay when the battery charging voltage is greater than the second reference voltage; and
a noise reducer configured to combine the first and second output signals and reduce noise included in the combined signal so as to output the first control signal.

16. The BMS of claim 15, wherein the second reference voltage range includes and is between third and fourth reference voltages, and
wherein the second battery protection circuit includes a microprocessor configured to output the second control signal when the battery charging voltage is less than the third reference voltage or greater than the fourth reference voltage.

17. The BMS claim of 13, wherein the controller is further configured to open the main relay only based on the first control signal when the second battery protection circuit malfunctions.

18. The BMS of claim 13, wherein the controller is further configured to open the main relay based on the first and second control signals.

19. The BMS of claim 13, wherein the first and second reference voltage ranges are different from each other.

20. The BMS of claim 13, wherein the first reference voltage range is greater than the second reference voltage range.
